(19) United States
(12) Patent Application Publication
(10) Pub. No.: US 2008/0127788 A1
(43) Pub. Date: Jun. 5, 2008

(54) TOOL WITH A LEATHER COVER

(76) Inventor: Chih-Ching Hsieh, Taichung City (TW)

Correspondence Address: Chih-Ching Hsieh, 235 Chung - Ho, Box 8-24, Taipei, 235, omitted

(21) Appl. No.: 11/855,166

(22) Filed: Sep. 14, 2007

Related U.S. Application Data
(63) Continuation-in-part of application No. 11/605,709, filed on Nov. 30, 2006, now abandoned.

(51) Int. Cl. B25G 1/10

(52) U.S. Cl. 81/492

(57) ABSTRACT

A tool with a leather cover enclosing a handle of the tool, comprises a tool body having at least one driving portion and a handle; a leather cover enclosing the handle as a holding section. The driving portion is selected from one of an opened driving portion, an adjustable driving portion, a ratchet driving portion, or a socket driving portion. The holding section is combined to the handle by high frequency combination, supersonic combination, seaming, gluing or high pressure.

The present invention is a continuation in part of U.S. patent application Ser. No. 11/605,709 which is assigned to and invented by the inventor and applicant of the present invention. Thus, the content of U.S. patent application Ser. No. 11/605,709 is incorporated into the present invention as a part of the present invention.

### FIELD OF THE INVENTION

The present invention relates to tools, and particularly to a tool with a leather cover, which is heat tolerant, cool tolerant, collision-proof, wear-proof, slide-proof and insulated.

### BACKGROUND OF THE INVENTION

The prior art hand tool is made of metal, which is smooth, and thus the hand holding the handle of the hand tool can not firmly hold the tool. Thereby since it is made of metal, it is not heat and cool tolerant and is not insulated so that the prior art hand tool is not a preferred one.

In one improved structure, the handle of the hand tool is formed with a plurality of particle like structure for slide proof.

However if the user's hand is polluted with oil or water, the slide proof effect of the hand tool is not good so as to affect the work of the user. Furthermore, the metal structure will hurt the user's hand as the hand holds the hand tool for a long time.

Moreover, the metal hand tool is electric and heat conductive. In cold day, the metal hand tool is cool so that the user's hand will feel cold and thus the work is affected. Even since the metal hand tool is conductive and thus it is possible the user will get electric shock due to short circuit. Thus from above discuss, it is known that the prior art design is not a preferred one.

### SUMMARY OF THE INVENTION

Accordingly, the primary object of the present invention is to provide a tool with a leather cover, which is heat tolerant, cool tolerant, collision-proof, wear-proof, slide-proof and insulated.

To achieve above objects, the present invention provides a tool with a leather cover enclosing a handle of the tool which comprises a tool body having at least one driving portion and a handle; a leather cover enclosing the handle as a holding section. The driving portion is selected from one of an opened driving portion, an adjustable driving portion, a ratchet driving portion, or a socket driving portion. The holding section is combined to the handle by high frequency combination, supersonic combination, seaming, gluing or high pressure.

The various objects and advantages of the present invention will be more readily understood from the following detailed description when read in conjunction with the appended drawing.

### BRIEF DESCRIPTION OF THE DRAWINGS

FIG. 1 is a schematic view of the tool with a leather cover of the present invention.

FIG. 2 is a perspective view showing the application of the tool with a leather cover of the present invention.

FIG. 3 is a schematic perspective view showing a second embodiment of the present invention.

FIG. 4 is a schematic view showing a third embodiment of the present invention.

FIG. 5 is a schematic view showing the fourth embodiment of the present invention.

FIG. 6 is a schematic view showing the fifth embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

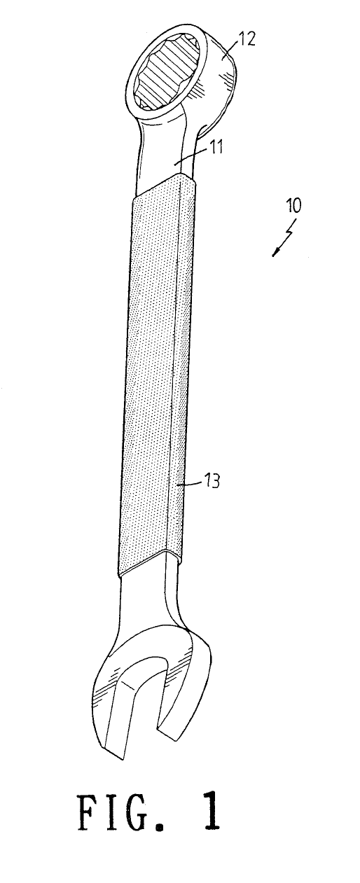

Referring to FIG. 1, the structure of the present invention is illustrated. The present invention has the following elements.

A tool body 10 has a handle 11. At least one end of the handle 11 has a driving portion 12. In this embodiment, one end of the handle 11 is a ring and another end is an opened driving portion. The driving portion 12 serves to drive a screw unit. A leather sleeve encloses the handle 11 by high frequency combination so as to form a holding section 13 which is heat tolerant, cool tolerant, collision-proof, wear-proof, slide-proof and insulated.

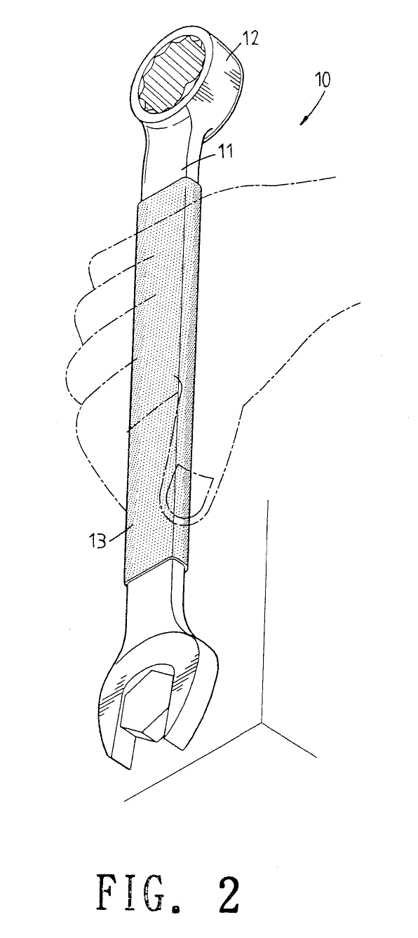

Referring to FIG. 2, in use of the present invention, the user holds the leather holding section 13 to drive the tool body 10. Not only the tool can be firmly held, but also it is slide-proof, heat-proof and insulated. Thereby the user's hand will not be hurt by react force in operation of the tool.

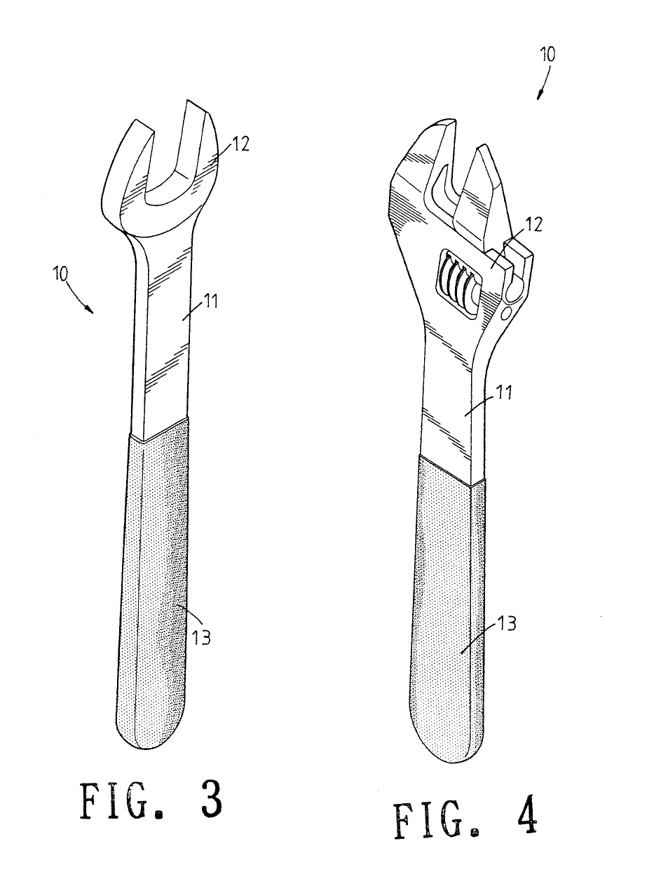

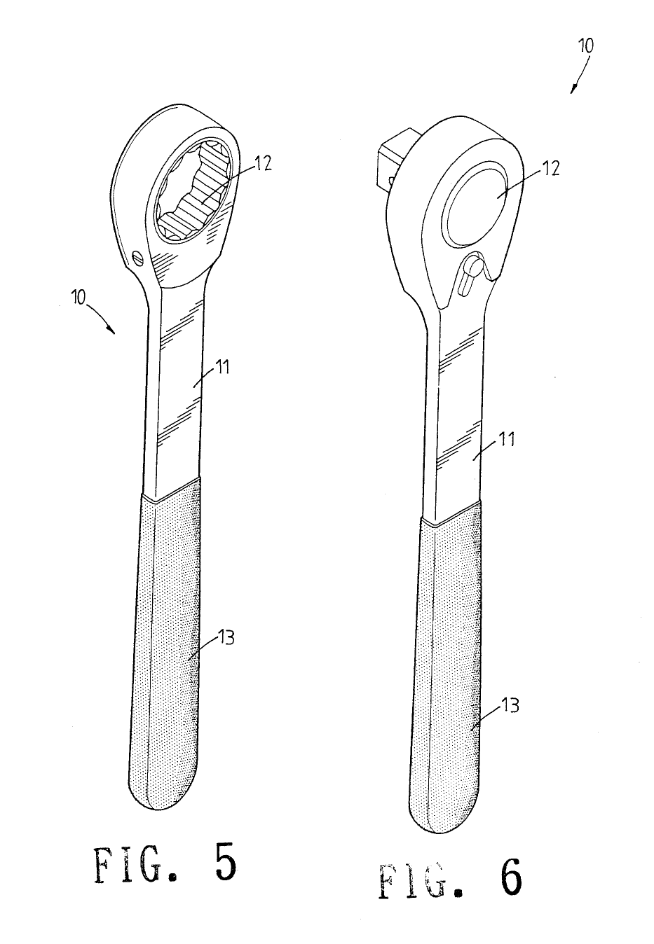

Referring to FIGS. 3 to 6, another embodiment of the present invention is illustrated. In this embodiment, those identical to the above embodiment will not be further described herein. Only those different from above embodiment are described. In this embodiment, only one end of the handle 11 has a driving portion 12, which is an opened driving portion 12 (referring to FIG. 3), an adjustable driving portion 12 (referring to FIG. 4), a ratchet driving portion 12 (referring to FIG. 5), or a socket driving portion 12 (referring to FIG. 6). All these are within the scope of the present invention.

Furthermore, in the present invention, an outer surface of the leather cover is formed with a plurality of fine particles so as to provide with a comfortable feeling to users as the user holds upon the leather cover in working. Furthermore the particles will provide friction forces to user's hand so that the user's hand will not slide out from the handle of the tool. Moreover, the particles are hemispherical particles and are integral formed on a surface of the leather cover.

In the present invention, the holding section is combined to the handle by high frequency combination, supersonic combination, seaming, gluing or high pressure.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A tool with a leather cover; a leather cover enclosing a handle of a tool, wherein
the tool having at least one driving portion and a handle; the leather cover encloses the handle as a holding section.

2. The tool with a leather cover as claimed in claim 1, wherein an outer surface of the leather cover is formed with a plurality of fine particles.

3. The tool with a level cover as claimed in claim 2, wherein the particles are hemispherical particles and are integral formed on a surface of the leather cover.

4. The tool with a leather cover as claimed in claim 3, wherein the driving portion is selected from one of an opened driving portion, an adjustable driving portion, a ratchet driving portion, and a socket driving portion.

5. The tool with a leather cover as claimed in claim 4, wherein the holding section is combined to the handle by high frequency combination, supersonic combination, seaming, gluing or high pressure.
